(19) United States
(12) Patent Application Publication
(10) Pub. No.: US 2025/0380329 A1
(43) Pub. Date: Dec. 11, 2025

(54) CONFIGURATION METHOD AND APPARATUS, DEVICE, AND READABLE STORAGE MEDIUM

(71) Applicant: VIVO MOBILE COMMUNICATION CO., LTD., Dongguan (CN)

(72) Inventor: Li CHEN, Dongguan (CN)

(21) Appl. No.: 19/300,700

(22) Filed: Aug. 15, 2025

Related U.S. Application Data
(63) Continuation of application No. PCT/CN2024/076510, filed on Feb. 7, 2024.

(30) Foreign Application Priority Data
Feb. 17, 2023 (CN) 202310142231.5

(51) Int. Cl. H04W 76/27

(52) U.S. Cl. CPC H04W 76/27

(57) ABSTRACT

This application discloses a configuration method and apparatus, a device, and a readable storage medium. The method includes: A terminal obtains configuration information of an NCD-SSB or configuration information of a CD-SSB, where the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

### CROSS-REFERENCE TO RELATED APPLICATIONS

This application is a continuation of International Patent Application No. PCT/CN2024/076510, filed on Feb. 7, 2024, which claims priority to Chinese Patent Application No. 202310142231.5, filed on Feb. 17, 2023 in China, both of which are incorporated herein by reference in their entirety.

### TECHNICAL FIELD

This application relates to the field of communications technologies, and specifically, to a configuration method and apparatus, a device, and a readable storage medium.

### BACKGROUND

In related technologies, for a terminal in an idle (Idle) state or inactive (Inactive) state, in a case that a random access channel (Random Access Channel, RACH) needs to be executed on a separate (separate) initial (Initial) bandwidth part (Bandwidth Part, BWP) or configured grant resource uplink small data transmission (Configured Grant-Small Data Transmission, CG-SDT) or random access-small data transmission (Random Access-Small Data Transmission, RA-SDT) is configured, the terminal needs to frequently retune the radio frequency back to the initial BWP to perform operations such as measurement, synchronization, or automatic gain control (Automatic Gain Control, AGC) via a cell-defining SSB (Cell-Defining Synchronization Signal and PBCH block, CD-SSB).

### SUMMARY

Embodiments of this application provide a configuration method and apparatus, a device, and a readable storage medium.

According to a first aspect, a configuration method is provided. The method includes:

A terminal obtains configuration information of an NCD-SSB or configuration information of a CD-SSB, where
the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

According to a second aspect, a configuration method is provided. The method includes:

A network side device sends configuration information of an NCD-SSB or configuration information of a CD-SSB, where
the configuration information of the NCD-SSB is used to configure a corresponding NCD-SSB for a terminal in an idle state or inactive state, and the configuration information of the CD-SSB is used to configure a corresponding CD-SSB for the terminal in the idle state or inactive state.

According to a third aspect, a configuration apparatus is provided, including:
a first obtaining module, configured to obtain configuration information of an NCD-SSB or configuration information of a CD-SSB, where
the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

According to a fourth aspect, a configuration apparatus is provided, including:
a first sending module, configured to send configuration information of an NCD-SSB or configuration information of a CD-SSB, where
the configuration information of the NCD-SSB is used to configure a corresponding NCD-SSB for a terminal in an idle state or inactive state, and the configuration information of the CD-SSB is used to configure a corresponding CD-SSB for the terminal in the idle state or inactive state.

According to a fifth aspect, a communication device is provided and includes a processor, a memory, and a program or an instruction that is stored in the memory and executable on the processor, and when the program or the instruction is executed by the processor, the steps of the method according to the first aspect or the second aspect are implemented.

According to a sixth aspect, a readable storage medium is provided. The readable storage medium stores a program or an instruction, and the program or the instruction is executed by a processor of a terminal to implement the steps of the method according to the first aspect, or is executed by a processor of a network side device to implement the steps of the method according to the second aspect.

According to a seventh aspect, a chip is provided. The chip includes a processor and a communication interface. The communication interface is coupled to the processor. The processor is configured to run a program or an instruction, to implement the steps of the method according to the first aspect or the second aspect.

According to an eighth aspect, a computer program/program product is provided, where the computer program/program product is stored in a non-transient storage medium, and the program/program product is executed by at least one processor to implement the steps of the method according to the first aspect or the second aspect.

According to a ninth aspect, a communication system is provided. The communication system includes a terminal and a network side device. The terminal is configured to perform the steps of the method according to the first aspect, and the network side device is configured to perform the steps of the method according to the second aspect.

### BRIEF DESCRIPTION OF DRAWINGS

FIG. 1 is a schematic diagram 1 of positions of a CD-SSB and an NCD-SSB;

FIG. 2 is a schematic diagram 2 of positions of a CD-SSB and an NCD-SSB;

FIG. 3 is a schematic diagram 3 of positions of a CD-SSB and an NCD-SSB;

FIG. 4 is a schematic diagram 4 of positions of a CD-SSB and an NCD-SSB;

FIG. 5 is a schematic diagram of an architecture of a wireless communication system according to an embodiment of this application;

FIG. 6 is a flowchart 1 of a configuration method according to an embodiment of this application;

FIG. 7 is a flowchart 2 of a configuration method according to an embodiment of this application;

FIG. 8 is a schematic diagram 1 of a configuration apparatus according to an embodiment of this application;

FIG. 9 is a schematic diagram 2 of a configuration apparatus according to an embodiment of this application;

FIG. 10 is a schematic diagram of a terminal according to an embodiment of this application;

FIG. 11 is a schematic diagram of a network side device according to an embodiment of this application; and

FIG. 12 is a schematic diagram of a communication device according to an embodiment of this application.

### DETAILED DESCRIPTION OF EMBODIMENTS

The following clearly describes the technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application means at least one of the connected objects. For example, “A or B” includes three solutions, namely: solution 1: include A but exclude B; solution 2: include B but exclude A; solution 3: include both A and B. The character “/” usually indicates an “or” relationship between the associated objects.

The term “indication” in this application may be a direct indication (or explicit indication) or an indirect indication (or implicit indication). The direct indication may be understood as that a sender explicitly notifies a sent indication of content such as specific information, an operation that needs to be performed, or a request result to a receiver. The indirect indication may be understood as that the receiver determines corresponding information according to the indication sent by the sender, or performs determining according to the indication sent by the sender, and determines, according to a determining result, the operation that needs to be performed, the request result, or the like.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following descriptions for illustrative purposes, and the NR terminology is used in most of the following descriptions, although these technologies can also be applied to a system other than the NR system, such as a 6^{th} generation (6^{th} Generation, 6G) communication system.

To better understand the embodiments of this application, the following technical points are first described.

### 1. Additionally Configured BWP

In new radio (New Radio, NR), a terminal performs one or more of the following operations on an initial downlink BWP (initial DL BWP, also referred to as a first downlink BWP in this specification) of a cell: receiving of a synchronization signal block, uplink sending in a random access procedure (corresponding to an initial uplink BWP (initial UL BWP)), downlink receiving, and receiving of system information and paging information; and performs radio resource management (Radio Resource Management, RRM) measurement and cell reselection determining based on a CD-SSB (Cell-Defining SSB, also referred to as a first SSB in this specification) on the initial downlink BWP.

Configuring an additional initial DL BWP (also referred to as a second downlink BWP in this specification) for some terminals (such as some types of terminals, for example, a reduced capability (Reduced Capability, Redcap) terminal) is supported. The terminal may perform the foregoing sending or receiving behavior on the additional BWP. The additional BWP and the first downlink BWP may be completely staggered, partially overlap, or have an inclusive relationship in frequency domain. Because the terminal needs to obtain operations such as downlink synchronization, measurement, and automatic gain control (Auto Gain Control, AGC) based on an SSB, in a case that the additional initial DL BWP does not include the SSB, the terminal may need to frequently perform radio frequency (Radio Frequency, RF) retuning (retuning), that is, need to frequently return from the additional initial DL BWP to a bandwidth of the first downlink BWP to receive the SSB. This results in increased power consumption of the terminal, an increased probability of service interruption, degradation of system performance, and the like.

### 2. Regarding a Frequency Position of an SSB in Network Deployment.

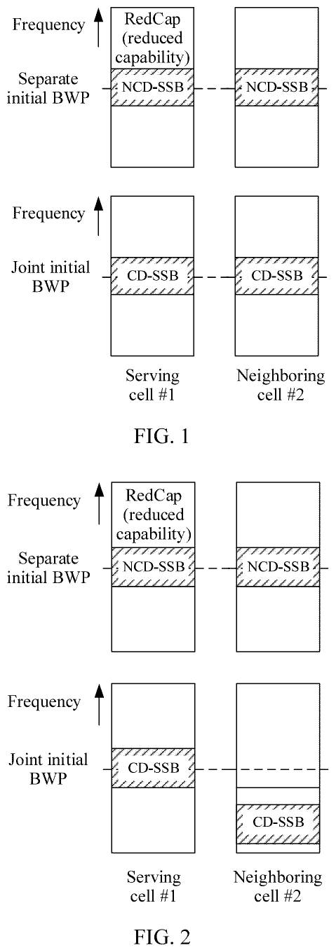

As shown in FIG. 1 to FIG. 4, positions of a CD-SSB and non cell-defining (Non Cell-Defining, NCD)-SSB in network deployment are flexible. At a frequency of the CD-SSB or the NCD-SSB, neighboring cells are not necessarily deployed.

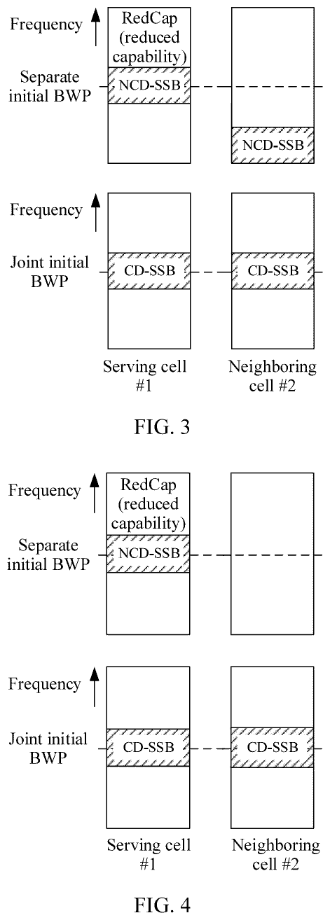

In FIG. 1, frequency positions of CD-SSBs are the same and frequency positions of NCD-SSBs are the same in two cells. In FIG. 2, frequencies of NCD-SSBs in two cells are the same, but frequencies of CD-SSBs are different. In FIG. 3 and FIG. 4, frequency positions of CD-SSBs in two cells are the same, but frequency positions of NCD-SSBs are different, or there is no NCD-SSB in a second cell.

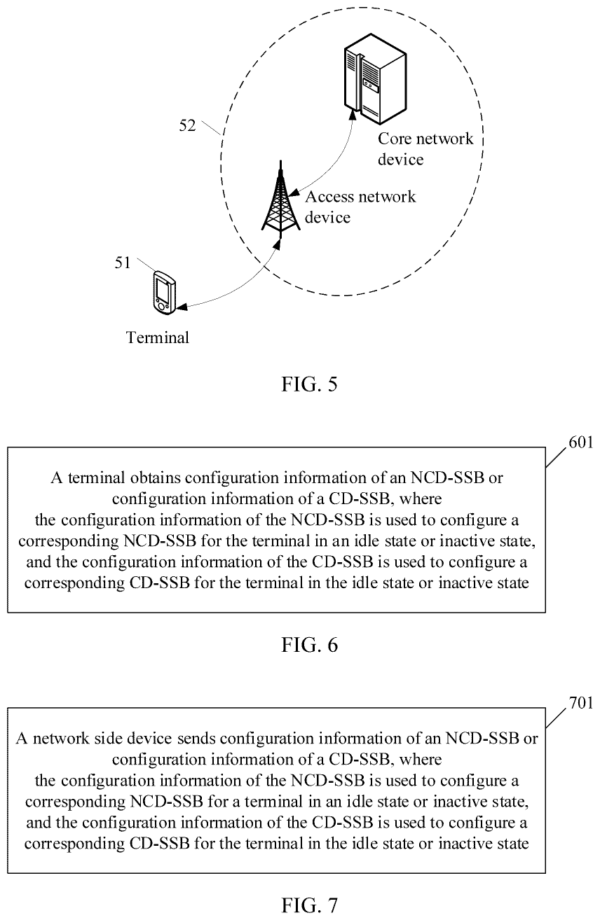

FIG. 5 is a block diagram of a wireless communication system to which embodiments of this application are applicable. The wireless communication system includes a terminal 51 and a network side device 52. The terminal 51 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), ship user equipment, pedestrian user equipment (Pedestrian User Equipment, PUE), a smart home (a home device with a wireless communication function, such as a refrigerator, a television, a washing machine, or a furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. The vehicle user equipment may also be referred to as a vehicle terminal, a vehicle controller, a vehicle module, a vehicle component, a vehicle chip, a vehicle unit, or the like. It should be noted that a specific type of the terminal 51 is not limited in the embodiments of this application. The network side device 52 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), wireless fidelity (Wireless Fidelity, WiFi) node, or the like. The base station may be referred to as a NodeB (NodeB, NB), an evolved NodeB (Evolved NodeB, eNB), a next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

The network side device 52 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Networks, WLAN) access point, a wireless fidelity (Wireless Fidelity, WiFi) node, or the like. The base station may be referred to as a NodeB, an evolved NodeB (evolved NodeB, eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), a unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that, in the embodiments of this application, only a core network device in an NR system is used as an example for description, and a specific type of the core network device is not limited.

Embodiments of this application provide a configuration method and apparatus, a device, and a readable storage medium, to resolve a problem that power consumption of a terminal and a service delay increase because the terminal needs to frequently return to an initial BWP and performs receiving or sending via a CD-SSB in the initial BWP.

A configuration method and apparatus, a communication device, and a readable storage medium provided in the embodiments of this application are described below in detail with reference to the accompanying drawings by using some embodiments and application scenarios thereof.

Refer to FIG. 6. An embodiment of this application provides a configuration method. The method is performed by a terminal and specifically includes step 601.

Step 601: The terminal obtains configuration information of an NCD-SSB or configuration information of a CD-SSB, where
the configuration information of the NCD-SSB or the configuration information of the CD-SSB is used to configure a corresponding NCD-SSB or CD-SSB for the terminal in an idle (idle) state or inactive (inactive) state.

In an implementation of this application, the method further includes:

The terminal obtains first information, where the first information is used to indicate at least one of the following:
(1) in a case that the terminal enters the idle state or inactive state, an NCD-SSB or a CD-SSB configured in a connected state remains valid or does not remain valid, where
for example, the first information includes 1 bit; and when a value of the bit in the first information is 1, it indicates that in a case that the terminal enters the idle state or inactive state, the NCD-SSB or the CD-SSB configured in the connected state remains valid; or when a value of the bit in the first information is 0, it indicates that in a case that the terminal enters the idle state or inactive state, the NCD-SSB or the CD-SSB configured in the connected state cannot remain valid; and
(2) the terminal in the idle state or inactive state is capable of or is incapable of using an NCD-SSB or a CD-SSB configured in a connected state, where
for example, the first information includes 1 bit; and when a value of the bit in the first information is 1, it indicates that the terminal in the idle state or inactive state is capable of using the NCD-SSB or the CD-SSB configured in the connected state; or when a value of the bit in the first information is 0, it indicates that the terminal in the idle state or inactive state is incapable of using the NCD-SSB or the CD-SSB configured in the connected state.

In this embodiment, the terminal in the idle state or inactive state may reuse the NCD-SSB or the CD-SSB configured by a network side when the terminal is in the connected state, to reduce signaling overheads.

In an implementation of this application, the method further includes:

The terminal obtains second information, where the second information is used to indicate at least one of the following:
(1) in a case that the terminal in the idle state or inactive state performs small data transmission (Small Data Transmission, SDT), an NCD-SSB or a CD-SSB configured in a connected state remains valid or does not remain valid, where
for example, the first information includes 1 bit; and when a value of the bit in the first information is 1, it indicates that in a case that the terminal enters the idle state or inactive state, the NCD-SSB or the CD-SSB configured in the connected state remains valid; or when a value of the bit in the first information is 0, it indicates that in a case that the terminal enters the idle state or inactive state, the NCD-SSB or the CD-SSB configured in the connected state cannot remain valid; and
(2) in a case that the terminal in the idle state or inactive state performs SDT, the terminal is capable of or is incapable of using an NCD-SSB or a CD-SSB configured in a connected state, where
for example, the first information includes 1 bit; and when a value of the bit in the first information is 1, it indicates that the terminal in the idle state or inactive state is capable of using the NCD-SSB or the CD-SSB configured in the connected state; or when a value of the bit in the first information is 0, it indicates that the terminal in the idle state or inactive state is incapable of using the NCD-SSB or the CD-SSB configured in the connected state. Configuration for a field information element (Information Element, IE) of the NCD-SSB or the CD-SSB needs (need) S, and is specified in a domain description (Field description). The above remains valid or may be used in the idle state or inactive state.

In this embodiment, the terminal in the idle state or inactive state may reuse the NCD-SSB or the CD-SSB configured by a network side when the terminal is in the connected state, to reduce signaling overheads.

In an implementation of this application, the configuration information of the NCD-SSB, the configuration information of the CD-SSB, the first information, or the second information is carried in at least one of the following:
(1) a radio resource control (Radio Resource Control, RRC) release (Release) message, where
for example, the terminal obtains the configuration information of the NCD-SSB or the configuration information of the CD-SSB through the RRC release message;
(2) an RRC configuration (RRC Configuration) message;
(3) an RRC reconfiguration (RRC Reconfiguration) message, where
for example, the terminal obtains the configuration information of the NCD-SSB or the configuration information of the CD-SSB through the RRC configuration message or the RRC reconfiguration message; and the terminal in the idle state or inactive state may reuse the configuration information of the NCD-SSB or the configuration information of the CD-SSB configured in the connected state; and
(4) a broadcast message.

Optionally, the broadcast message includes system information (System Information, SI). For example, the terminal may obtain the configuration information of the NCD-SSB or the configuration information of the CD-SSB for SDT through the broadcast message.

It should be noted that the configuration information of the NCD-SSB or the configuration information of the CD-SSB and the first information or the second information may be carried in a same RRC release message, RRC configuration message, RRC reconfiguration message, or broadcast message, or the configuration information of the NCD-SSB or the configuration information of the CD-SSB and the first information or the second information may be carried in different RRC release messages, RRC configuration messages, RRC reconfiguration messages, or broadcast messages.

In an implementation of this application, time during which the configuration information of the NCD-SSB or the configuration information of the CD-SSB is invalid or unavailable includes at least one of the following:
(1) after a first preset time period after the terminal receives or demodulates a message carrying the configuration information of the NCD-SSB or the configuration information of the CD-SSB;
(2) after a second preset time period after the terminal enters from the connected state to the idle state or inactive state;
(3) after a third preset time period after the terminal selects or reselects a target cell;
(4) after a fourth preset time period after the terminal selects or reselects a cell other than a target cell; and
(5) a preset timer expires, where the preset timer is started in a case that a validity condition for the configuration information of the NCD-SSB or the configuration information of the CD-SSB is met.

In this embodiment, the terminal may determine, based on the time during which the configuration information of the NCD-SSB or the configuration information of the CD-SSB is invalid or unavailable, that the configuration information of the NCD-SSB or the configuration information of the CD-SSB is invalid, to reduce signaling overheads.

Optionally, the first preset time period, the second preset time period, the third preset time period, the fourth preset time period, or the preset timer may be agreed upon in a protocol or configured by the network side.

Optionally, the first preset time period, the second preset time period, the third preset time period, the fourth preset time period, or the preset timer may be configured by the network side through the RRC release message, the RRC configuration message, the RRC reconfiguration message, or the broadcast message.

Optionally, a related configuration of the first preset time period, the second preset time period, the third preset time period, the fourth preset time period, or the preset timer and the configuration information of the NCD-SSB or the configuration information of the CD-SSB may be carried in a same RRC release message, RRC configuration message, RRC reconfiguration message, or broadcast message; or a related configuration of the first preset time period, the second preset time period, the third preset time period, the fourth preset time period, or the preset timer and the configuration information of the NCD-SSB or the configuration information of the CD-SSB may be carried in different RRC release messages, RRC configuration messages, RRC reconfiguration messages, or broadcast messages.

In an implementation of this application, the validity condition for the configuration information of the NCD-SSB or the configuration information of the CD-SSB includes one of the following:
(1) the terminal receives or demodulates the message carrying the configuration information of the NCD-SSB or the configuration information of the CD-SSB;
(2) the terminal enters from the connected state to the idle state or inactive state; and
(3) the target cell is selected or reselected.

In this embodiment, the terminal may determine, based on the validity condition for the configuration information of the NCD-SSB or the configuration information of the CD-SSB, that the configuration information of the NCD-SSB or the configuration information of the CD-SSB is valid, to reduce signaling overheads.

In an implementation of this application, validity time for the configuration information of the NCD-SSB or the configuration information of the CD-SSB includes one of the following:
(1) after the terminal receives or demodulates the message carrying the configuration information of the NCD-SSB or the configuration information of the CD-SSB;
(2) after the terminal enters from the connected state to the idle state or inactive state;
and
(3) the target cell is selected or reselected.

The target cell includes at least one of the following:
(a) a cell in which the message carrying the configuration information of the NCD-SSB or the configuration information of the CD-SSB is received;
(b) a cell in which the terminal is located before entering the idle state or inactive state; and
(c) a cell in which the terminal is located when or after entering the idle state or inactive state.

In this embodiment, the terminal may determine, based on the validity time for the configuration information of the NCD-SSB or the configuration information of the CD-SSB, that the configuration information of the NCD-SSB or the configuration information of the CD-SSB is valid, to reduce signaling overheads.

In an implementation of this application, a validity range of the configuration information includes one of the following: a target cell and an area in which a target cell is located.

In an implementation of this application, the area includes at least one of the following:
(1) a radio access network notification area (RAN-based Notification Area, RNA);
(2) a public land mobile network (Public Land Mobile Network, PLMN);
(3) a tracking area (Tracking Area, TA);
(4) a paging area (Paging area);
(5) a central unit (Central Unit, CU) range; and
(6) a distributed unit (Distributed Unit, DU) range.

In an implementation of this application, the method further includes:

In a case that the terminal selects or reselects the target cell or an area in which the target cell is located, the terminal determines that the configuration information of the NCD-SSB or the configuration information of the CD-SSB is invalid.

It should be noted that the configuration information of the NCD-SSB or the configuration information of the CD-SSB received by the terminal outside the target cell or outside the area in which the target cell is located can still be used.

In an implementation of this application, the method further includes:

In a case that the terminal selects or reselects the target cell or an area in which the target cell is located, the terminal determines that the configuration information of the NCD-SSB or the configuration information of the CD-SSB is valid, or determines that the configuration information of the NCD-SSB or the configuration information of the CD-SSB is capable of being used in the idle state or inactive state.

Optionally, in a case that the configuration information of the NCD-SSB or the configuration information of the CD-SSB may remain valid or may be used in the idle state or inactive state in the first preset time period, the second preset time period, the third preset time period, the fourth preset time period, or the preset timer,

Selecting or reselecting the target cell or the area in which the target cell is located includes selecting or reselecting the target cell or the area in which the target cell is located again.

In this embodiment, the terminal may determine, based on a case of cell selection or reselection, that the configuration information of the NCD-SSB or the configuration information of the CD-SSB is valid, or determine that the configuration information of the NCD-SSB or the configuration information of the CD-SSB can be used in the idle state or inactive state, to reduce signaling overheads.

In an implementation of this application, the method further includes:

In a case that the terminal selects or reselects the target cell or an area in which the target cell is located and a validity condition for the configuration information of the NCD-SSB or the configuration information of the CD-SSB is met, the terminal determines that the configuration information of the NCD-SSB or the configuration information of the CD-SSB is valid, or determines that the configuration information of the NCD-SSB or the configuration information of the CD-SSB is capable of being used in the idle state or inactive state.

That the terminal selects or reselects the target cell or the area in which the target cell is located may include: The terminal selects or reselects the target cell or the area in which the target cell is located again.

In this embodiment, in a case that the validity condition for the configuration information of the NCD-SSB or the configuration information of the CD-SSB is met, the terminal may determine, based on a case of cell selection or reselection, that the configuration information of the NCD-SSB or the configuration information of the CD-SSB is valid, or determine that the configuration information of the NCD-SSB or the configuration information of the CD-SSB can be used in the idle state or inactive state, to reduce signaling overheads.

In an implementation of this application, the target cell includes at least one of the following:
(1) a cell in which the message carrying the configuration information of the NCD-SSB or the configuration information of the CD-SSB is received or demodulated, where
for example, in a case that the terminal receives the message carrying the configuration information of the NCD-SSB or the configuration information of the CD-SSB in a cell 1, the cell 1 is the target cell;
(2) a cell in which the terminal is located before entering the idle state or inactive state, where
for example, in a case that the cell in which the terminal is located before entering the idle state or inactive state is a cell 1, the cell 1 is the target cell;
(3) a cell in which the terminal is located when entering the idle state or inactive state, where
for example, in a case that the cell in which the terminal is located when entering the idle state or inactive state is a cell 1, the cell 1 is the target cell; and
(4) a cell in which the terminal is located after entering the idle state or inactive state, where
for example, in a case that the cell in which the terminal is located after entering the idle state or inactive state is a cell 1, the cell 1 is the target cell;

It may be understood that the cell may be replaced with a TRP.

In an implementation of this application, the method further includes:

The terminal performs a first operation in the idle state or inactive state according to the configuration information, where
the first operation includes at least one of the following:
(1) small data transmission, where
optionally, the small data transmission includes at least one of the following: small data transmission without subsequent (SDT without Subsequent) transmission, small data transmission with subsequent transmission (SDT with Subsequent) transmission, where the subsequent (Subsequent) transmission includes at least one of the following: configured grant (Configured Grant, CG) transmission and dynamic grant (Dynamic Grant, DG) transmission;
(2) random access;
(3) radio resource management (Radio Resource Management, RRM) measurement;
(4) early measurement (Early measurement);
(5) measurement corresponding to cell selection/reselection;
(6) measurement corresponding to public land mobile network selection;
(7) measurement corresponding to random access resource selection;
(8) measurement corresponding to configured grant physical uplink shared channel (Physical Uplink Shared Channel, PUSCH) resource selection;
(9) receiving a paging message;
(10) receiving a broadcast message;
(11) receiving a paging early indication (Paging Early Indication, PEI);
(12) receiving a wake-up signal (Wake-Up Signal, WUS), where
optionally, the wake-up signal includes a lower power wake-up signal (Lower Power-WUS, LP-WUS); and
(13) another operation in the idle state or inactive state.

In an implementation of this application, that the terminal performs a first operation in the idle state or inactive state according to the configuration information of the NCD-SSB or the configuration information of the CD-SSB includes at least one of the following:
the terminal performs the first operation in the idle state or inactive state according to the configuration information of the NCD-SSB or the configuration information of the CD-SSB obtained through an RRC release message, an RRC configuration message, or an RRC reconfiguration message; and the terminal performs the first operation in the idle state or inactive state according to the configuration information of the NCD-SSB or the configuration information of the CD-SSB obtained through a broadcast message;
in a case that the configuration information of the NCD-SSB or the configuration information of the CD-SSB is obtained through an RRC release message, an RRC configuration message, or an RRC reconfiguration message, and a broadcast message, performing the first operation in the idle state or inactive state according to the configuration information of the NCD-SSB or the configuration information of the CD-SSB obtained through the RRC release message, the RRC configuration message, or the RRC reconfiguration message;
in a case that the configuration information of the NCD-SSB or the configuration information of the CD-SSB is obtained through an RRC release message, an RRC configuration message, or an RRC reconfiguration message, and a broadcast message, performing a first partial operation of the first operation in the idle state or inactive state according to the configuration information of the NCD-SSB or the configuration information of the CD-SSB obtained through the RRC release message, the RRC configuration message, or the RRC reconfiguration message; and
in a case that the configuration information of the NCD-SSB or the configuration information of the CD-SSB is obtained through an RRC release message, an RRC configuration message, or an RRC reconfiguration message, and a broadcast message, the terminal performs a second partial operation of the first operation in the idle state or inactive state according to the configuration information of the NCD-SSB or the configuration information of the CD-SSB obtained through the broadcast message.

Optionally, the first partial operation includes small data transmission or random access, and the second partial operation includes at least one of the following: radio resource management measurement, early measurement, measurement corresponding to cell selection/reselection, measurement corresponding to public land mobile network selection, measurement corresponding to configured grant physical uplink shared channel resource selection, receiving a paging message, receiving a broadcast message, receiving a paging early indication, receiving a wake-up signal, and another operation in the idle state or inactive state.

In this embodiment, the corresponding configuration information of the NCD-SSB or the corresponding configuration information of the CD-SSB is used in different scenarios.

In an implementation of this application, the configuration information of the NCD-SSB or the configuration information of the CD-SSB includes at least one of the following:
(1) a physical cell identifier (Physical Cell Identifier, PCI);
(2) a transmit power;
for example, a transmit power of a synchronization signal block, where optionally, the transmit power may be represented by a parameter SSB-PBCH-BlockPower;
(3) a sending periodicity;
for example, a periodicity of the synchronization signal block, where optionally, the sending periodicity may be represented by a parameter SSB-Periodicity;
(4) a sending position;
for example, a time domain position of the synchronization signal block, where optionally, the sending position may be represented by a parameter SSB-PositionsInBurst;
(5) frequency information;
for example, frequency information of the synchronization signal block, where optionally, the frequency information may be represented by a parameter absoluteFrequencySSB;
(6) a synchronization signal block index (SSB block index); and
(7) a quasi co-located (Quasi Co-located, QCL) resource with another synchronization signal block.

In the embodiments of this application, the terminal obtains the configuration information of the NCD-SSB or the configuration information of the CD-SSB, where the configuration information of the NCD-SSB is used to configure the corresponding NCD-SSB for the terminal in the idle state or inactive state, and the configuration information of the CD-SSB is used to configure the corresponding CD-SSB for the terminal in the idle state or inactive state. In this way, the terminal in the idle state or inactive state may perform sending or receiving behavior via the CD-SSB or the NCD-SSB, to avoid the problem that the power consumption of the terminal and the service delay increase because the terminal frequently returns to the initial BWP and performs sending or receiving via the CD-SSB.

Refer to FIG. 7. An embodiment of this application provides a configuration method. The method is performed by a network side device and specifically includes step 701.

Step 701: The network side device sends configuration information of an NCD-SSB or configuration information of a CD-SSB, where
the configuration information of the NCD-SSB is used to configure a corresponding NCD-SSB for a terminal in an idle state or inactive state, and the configuration information of the CD-SSB is used to configure a corresponding CD-SSB for the terminal in the idle state or inactive state.

In an implementation of this application, the method further includes:

The network side device sends first information, where the first information is used to indicate at least one of the following:
(1) in a case that the terminal enters the idle state or inactive state, an NCD-SSB or a CD-SSB configured in a connected state remains valid or does not remain valid; and
(2) the terminal in the idle state or inactive state is capable of or is incapable of using an NCD-SSB or a CD-SSB configured in a connected state.

In an implementation of this application, the method further includes:

The network side device sends second information, where the second information is used to indicate at least one of the following:
(1) in a case that the terminal in the idle state or inactive state performs SDT, an NCD-SSB or a CD-SSB configured in a connected state remains valid or does not remain valid; and
(2) in a case that the terminal in the idle state or inactive state performs SDT, the terminal is capable of or is incapable of using an NCD-SSB or a CD-SSB configured in a connected state.

In an implementation of this application, the configuration information of the NCD-SSB, the configuration information of the CD-SSB, the first information, or the second information is carried in at least one of the following:
(1) an RRC release message;
(2) an RRC configuration message;
(3) an RRC reconfiguration message; and
(4) a broadcast message.

In an implementation of this application, time during which the configuration information of the NCD-SSB or the configuration information of the CD-SSB is invalid or unavailable includes at least one of the following:
(1) after a first preset time period after the terminal receives or demodulates a message carrying the configuration information of the NCD-SSB or the configuration information of the CD-SSB;
(2) after a second preset time period after the terminal enters from the connected state to the idle state or inactive state;
(3) after a third preset time period after the terminal selects or reselects a target cell;
(4) after a fourth preset time period after the terminal selects or reselects a cell other than a target cell; and
(5) a preset timer expires, where the preset timer is started in a case that a validity condition for the configuration information of the NCD-SSB or the configuration information of the CD-SSB is met.

In an implementation of this application, the validity condition for the configuration information of the NCD-SSB or the configuration information of the CD-SSB includes one of the following:
(1) the terminal receives or demodulates the message carrying the configuration information of the NCD-SSB or the configuration information of the CD-SSB;
(2) the terminal enters from the connected state to the idle state or inactive state; and
(3) the target cell is selected or reselected.

In an implementation of this application, a validity range of the configuration information of the NCD-SSB or the configuration information of the CD-SSB includes one of the following: a target cell and an area in which a target cell is located.

In an implementation of this application, the area includes at least one of the following:
(1) a radio access network notification area;
(2) a public land mobile network;
(3) a tracking area;
(4) a paging area;
(5) a central unit range; and
(6) a distributed unit range.

In an implementation of this application, the target cell includes at least one of the following:
(1) a cell in which the message carrying the configuration information of the NCD-SSB or the configuration information of the CD-SSB is received or demodulated;
(2) a cell in which the terminal is located before entering the idle state or inactive state;
(3) a cell in which the terminal is located when entering the idle state or inactive state; and
(4) a cell in which the terminal is located after entering the idle state or inactive state.

In an implementation of this application, the configuration information of the NCD-SSB or the configuration information of the CD-SSB includes at least one of the following:
(1) a physical cell identifier;
(2) a transmit power;
(3) a sending periodicity;
(4) a sending position;
(5) frequency information;
(6) a synchronization signal block index; and
(7) a quasi co-located resource with another synchronization signal block.

In the embodiments of this application, the network side device sends the configuration information of the NCD-SSB or the configuration information of the CD-SSB, where the configuration information of the NCD-SSB is used to configure the corresponding NCD-SSB for the terminal in the idle state or inactive state, and the configuration information of the CD-SSB is used to configure the corresponding CD-SSB for the terminal in the idle state or inactive state. In this way, the terminal in the idle state or inactive state may perform sending or receiving behavior via the CD-SSB or the NCD-SSB, to avoid the problem that the power consumption of the terminal and the service delay increase because the terminal frequently returns to the initial BWP and performs sending or receiving via the CD-SSB.

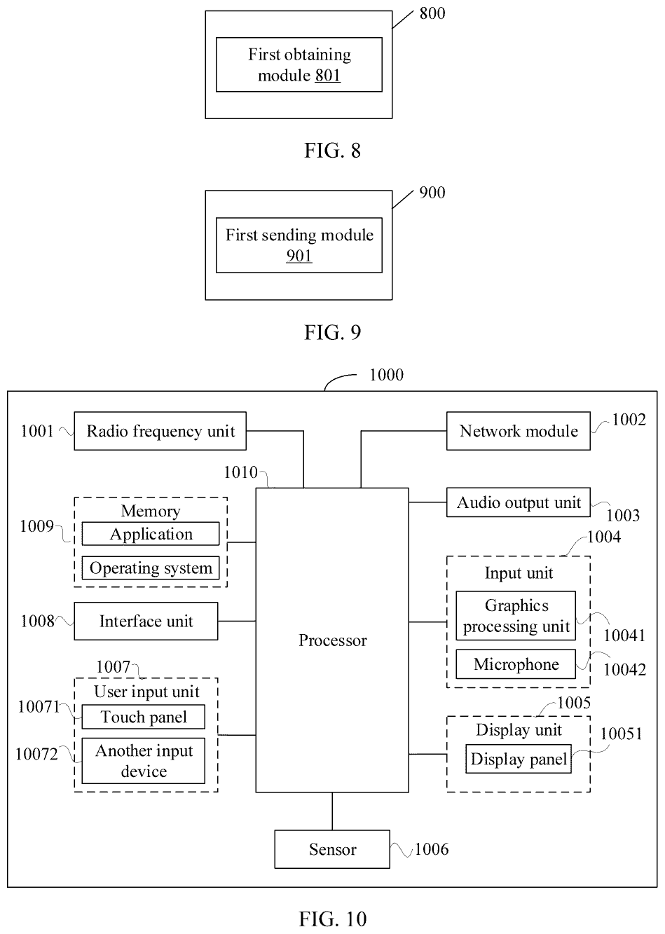

Refer to FIG. 8. An embodiment of this application provides a configuration apparatus, applied to a terminal. The apparatus 800 includes:
a first obtaining module 801, configured to obtain configuration information of an NCD-SSB or configuration information of a CD-SSB, where
the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

In an implementation of this application, the apparatus further includes:
a second obtaining module, configured to obtain first information, where the first information is used to indicate at least one of the following:
(1) in a case that the terminal enters the idle state or inactive state, an NCD-SSB or a CD-SSB configured in a connected state remains valid or does not remain valid; and
(2) the terminal in the idle state or inactive state is capable of or is incapable of using an NCD-SSB or a CD-SSB configured in a connected state.

In an implementation of this application, the apparatus further includes:
a third obtaining module, configured to obtain second information, where the second information is used to indicate at least one of the following:
(1) in a case that the terminal in the idle state or inactive state performs SDT, an NCD-SSB or a CD-SSB configured in a connected state remains valid or does not remain valid; and
(2) in a case that the terminal in the idle state or inactive state performs SDT, the terminal is capable of or is incapable of using an NCD-SSB or a CD-SSB configured in a connected state.

In an implementation of this application, the configuration information, the first information, or the second information is carried in at least one of the following:
(1) an RRC release message;
(2) an RRC configuration message;
(3) an RRC reconfiguration message; and
(4) a broadcast message.

In an implementation of this application, time during which the configuration information is invalid or unavailable includes at least one of the following:
(1) after a first preset time period after the terminal receives or demodulates a message carrying the configuration information of the NCD-SSB or the configuration information of the CD-SSB;
(2) after a second preset time period after the terminal enters from the connected state to the idle state or inactive state;
(3) after a third preset time period after the terminal selects or reselects a target cell;
(4) after a fourth preset time period after the terminal selects or reselects a cell other than a target cell; and
(5) a preset timer expires, where the preset timer is started in a case that a validity condition for the configuration information of the NCD-SSB or the configuration information of the CD-SSB is met.

In an implementation of this application, the validity condition for the configuration information of the NCD-SSB or the configuration information of the CD-SSB includes one of the following:
(1) the terminal receives or demodulates the message carrying the configuration information of the NCD-SSB or the configuration information of the CD-SSB;
(2) the terminal enters from the connected state to the idle state or inactive state; and
(3) the target cell is selected or reselected.

In an implementation of this application, a validity range of the configuration information of the NCD-SSB or the configuration information of the CD-SSB includes one of the following: a target cell and an area in which a target cell is located.

In an implementation of this application, the area includes at least one of the following:
(1) a radio access network notification area;
(2) a public land mobile network;
(3) a tracking area;
(4) a paging area;
(5) a central unit range; and
(6) a distributed unit range.

In an implementation of this application, the apparatus further includes:
a first determining module, configured to: in a case that the terminal selects or reselects the target cell or an area in which the target cell is located, determine that the configuration information of the NCD-SSB or the configuration information of the CD-SSB is invalid.

In an implementation of this application, the apparatus further includes:
a second determining module, configured to: in a case that the terminal selects or reselects the target cell or an area in which the target cell is located, determine that the configuration information of the NCD-SSB or the configuration information of the CD-SSB is valid, or determine that the configuration information of the NCD-SSB or the configuration information of the CD-SSB is capable of being used in the idle state or inactive state.

In an implementation of this application, the apparatus further includes:
a third determining module, configured to: in a case that the terminal selects or reselects the target cell or an area in which the target cell is located and a validity condition for the configuration information of the NCD-SSB or the configuration information of the CD-SSB is met, determine that the configuration information of the NCD-SSB or the configuration information of the CD-SSB is valid, or determine that the configuration information of the NCD-SSB or the configuration information of the CD-SSB is capable of being used in the idle state or inactive state.

In an implementation of this application, the target cell includes at least one of the following:
(1) a cell in which the message carrying the configuration information of the NCD-SSB or the configuration information of the CD-SSB is received or demodulated;
(2) a cell in which the terminal is located before entering the idle state or inactive state;
(3) a cell in which the terminal is located when entering the idle state or inactive state; and
(4) a cell in which the terminal is located after entering the idle state or inactive state.

In an implementation of this application, the apparatus further includes:
a processing module, configured to perform a first operation in the idle state or inactive state according to the configuration information of the NCD-SSB or the configuration information of the CD-SSB, where
the first operation includes at least one of the following:
(1) small data transmission;
(2) random access;
(3) radio resource management measurement;
(4) early measurement;
(5) measurement corresponding to cell selection/reselection;
(6) measurement corresponding to public land mobile network selection;
(7) measurement corresponding to random access resource selection;
(8) measurement corresponding to configured grant physical uplink shared channel resource selection;
(9) receiving a paging message;
(10) receiving a broadcast message;
(11) receiving a paging early indication (paging early indication);
(12) receiving a wake-up signal WUS; and
(13) another operation in the idle state or inactive state.

In an implementation of this application, the small data transmission includes at least one of the following: small data transmission without subsequent transmission and small data transmission with subsequent transmission, where the subsequent transmission includes at least one of the following: configured grant transmission and dynamic grant transmission.

In an implementation of this application, the processing module is further configured to:
perform the first operation in the idle state or inactive state according to the configuration information of the NCD-SSB or the configuration information of the CD-SSB obtained through an RRC release message, an RRC configuration message, or an RRC reconfiguration message; and perform the first operation in the idle state or inactive state according to the configuration information of the NCD-SSB or the configuration information of the CD-SSB obtained through a broadcast message;
in a case that the configuration information of the NCD-SSB or the configuration information of the CD-SSB is obtained through an RRC release message, an RRC configuration message, or an RRC reconfiguration message, and a broadcast message, perform the first operation in the idle state or inactive state according to the configuration information of the NCD-SSB or the configuration information of the CD-SSB obtained through the RRC release message, the RRC configuration message, or the RRC reconfiguration message;
in a case that the configuration information of the NCD-SSB or the configuration information of the CD-SSB is obtained through an RRC release message, an RRC configuration message, or an RRC reconfiguration message, and a broadcast message, perform a first partial operation of the first operation in the idle state or inactive state according to the configuration information of the NCD-SSB or the configuration information of the CD-SSB obtained through the RRC release message, the RRC configuration message, or the RRC reconfiguration message; and
in a case that the configuration information of the NCD-SSB or the configuration information of the CD-SSB is obtained through an RRC release message, an RRC configuration message, or an RRC reconfiguration message, and a broadcast message, perform a second partial operation of the first operation in the idle state or inactive state according to the configuration information of the NCD-SSB or the configuration information of the CD-SSB obtained through the broadcast message.

In an implementation of this application, the configuration information of the NCD-SSB or the configuration information of the CD-SSB includes at least one of the following:
(1) a physical cell identifier;
(2) a transmit power;
(3) a sending periodicity;
(4) a sending position;
(5) frequency information;
(6) a synchronization signal block index; and
(7) a quasi co-located resource with another synchronization signal block.

The apparatus provided in this embodiment of this application can implement the processes implemented in the method embodiment of FIG. 6 and achieve the same technical effect. To avoid repetition, details are not described herein again.

Refer to FIG. 9. An embodiment of this application provides a configuration apparatus, applied to a network side device. The apparatus 900 includes:
a first sending module 901, configured to send configuration information of an NCD-SSB or configuration information of a CD-SSB, where
the configuration information of the NCD-SSB is used to configure a corresponding NCD-SSB for a terminal in an idle state or inactive state, and the configuration information of the CD-SSB is used to configure a corresponding CD-SSB for the terminal in the idle state or inactive state.

In an implementation of this application, the apparatus further includes:
a second sending module, configured to send first information, where the first information is used to indicate at least one of the following:
(1) in a case that the terminal enters the idle state or inactive state, an NCD-SSB or a CD-SSB configured in a connected state remains valid or does not remain valid; and
(2) the terminal in the idle state or inactive state is capable of or is incapable of using an NCD-SSB or a CD-SSB configured in a connected state.

In an implementation of this application, the apparatus further includes:
a third sending module, configured to send second information, where the second information is used to indicate at least one of the following:
(1) in a case that the terminal in the idle state or inactive state performs SDT, whether an NCD-SSB or a CD-SSB configured in a connected state remains valid; and
(2) in a case that the terminal in the idle state or inactive state performs SDT, whether the terminal is capable of using an NCD-SSB or a CD-SSB configured in a connected state.

In an implementation of this application, the configuration information of the NCD-SSB, the configuration information of the CD-SSB, the first information, or the second information is carried in at least one of the following:
(1) an RRC release message;
(2) an RRC configuration message;
(3) an RRC reconfiguration message; and
(4) a broadcast message.

In an implementation of this application, time during which the configuration information of the NCD-SSB or the configuration information of the CD-SSB is invalid or unavailable includes at least one of the following:
(1) after a first preset time period after the terminal receives or demodulates a message carrying the configuration information of the NCD-SSB or the configuration information of the CD-SSB;
(2) after a second preset time period after the terminal enters from the connected state to the idle state or inactive state;
(3) after a third preset time period after the terminal selects or reselects a target cell;
(4) after a fourth preset time period after the terminal selects or reselects a cell other than a target cell; and
(5) a preset timer expires, where the preset timer is started in a case that a validity condition for the configuration information of the NCD-SSB or the configuration information of the CD-SSB is met.

In an implementation of this application, the validity condition for the configuration information of the NCD-SSB or the configuration information of the CD-SSB includes one of the following:
(1) the terminal receives or demodulates the message carrying the configuration information of the NCD-SSB or the configuration information of the CD-SSB;
(2) the terminal enters from the connected state to the idle state or inactive state; and
(3) the target cell is selected or reselected.

In an implementation of this application, a validity range of the configuration information of the NCD-SSB or the configuration information of the CD-SSB includes one of the following: a target cell and an area in which a target cell is located.

In an implementation of this application, the area includes at least one of the following:
(1) a radio access network notification area;
(2) a public land mobile network;
(3) a tracking area;
(4) a paging area;
(5) a central unit range; and
(6) a distributed unit range.

In an implementation of this application, the target cell includes at least one of the following:
(1) a cell in which the message carrying the configuration information of the NCD-SSB or the configuration information of the CD-SSB is received or demodulated;
(2) a cell in which the terminal is located before entering the idle state or inactive state;
(3) a cell in which the terminal is located when entering the idle state or inactive state; and
(4) a cell in which the terminal is located after entering the idle state or inactive state.

In an implementation of this application, the configuration information of the NCD-SSB or the configuration information of the CD-SSB includes at least one of the following:
(1) a physical cell identifier;
(2) a transmit power;
(3) a sending periodicity;
(4) a sending position;
(5) frequency information;
(6) a synchronization signal block index; and
(7) a quasi co-located resource with another synchronization signal block.

The apparatus provided in this embodiment of this application can implement the processes implemented in the method embodiment of FIG. 7 and achieve the same technical effect. To avoid repetition, details are not described herein again.

FIG. 10 is a schematic diagram of a hardware structure of a terminal according to an embodiment of this application. The terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a graphics processing unit (Graphics Processing Unit, GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 610 for processing. In addition, the radio frequency unit 1001 may send uplink data to the network side device. Usually, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may include a volatile memory or a non-volatile memory, or the memory 1009 may include a non-transitory memory. The non-volatile memory or the non-transitory memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any memory of another proper type.

The processor 1010 may include one or more processing units. Optionally, an application processor and a modem processor are integrated into the processor 1010. The application processor mainly processes an operating system, a user interface, an application, and the like. The modem processor mainly processes a wireless communication signal, for example, a baseband processor. It may be understood that, alternatively, the modem processor may not be integrated into the processor 1010.

The terminal provided in this embodiment of this application can implement the processes implemented in the method embodiment of FIG. 6, and achieve a same technical effect. To avoid repetition, details are not described herein again.

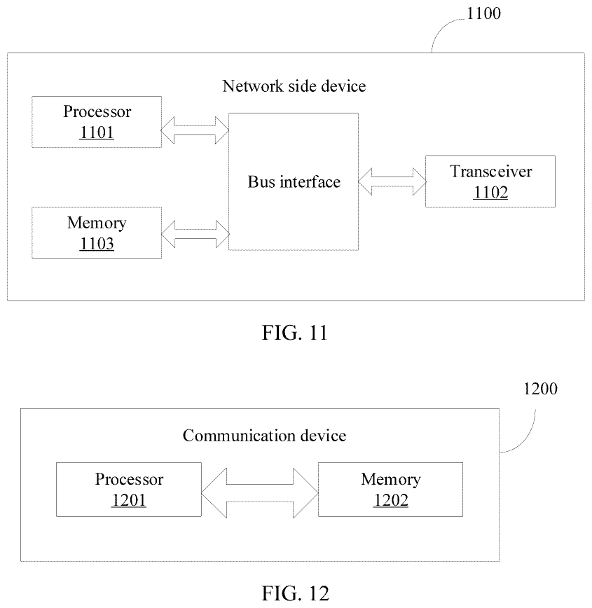

Refer to FIG. 11. FIG. 11 is a diagram of a structure of a network side device applied to an embodiment of this application. As shown in FIG. 11, the network side device 1100 includes: a processor 1101, a transceiver 1102, a memory 1103, and a bus interface, where the processor 1101 may be responsible for bus architecture management and general processing. The memory 1103 may store data used by the processor 1101 when the processor performs an operation.

In an embodiment of this application, the network side device 1100 further includes a program that is stored in the memory 1103 and executable on the processor 1101. When the program is executed by the processor 1101, the steps in the method shown in FIG. FIG. 7 are implemented.

In FIG. 11, a bus architecture may include any quantity of interconnected buses and bridges, which are specifically linked together by various circuits of one or more processors represented by the processor 1101 and a memory represented by the memory 1103. The bus architecture may further link various other circuits together such as a peripheral device, a voltage regulator, and a power management circuit. These are all well-known in the art, and therefore are not further described in this specification. The bus interface provides an interface. The transceiver 1102 may be a plurality of elements, in other words, includes a transmitter and a receiver, and provides a unit configured to communicate with various other apparatuses on a transmission medium.

As shown in FIG. 12, an embodiment of this application further provides a communication device 1200, including a processor 1201 and a memory 1202. The memory 1202 stores a program or an instruction that is executable on the processor 1201. For example, when the communication device 1200 is a terminal, the program or the instruction is executed by the processor 1201 to implement the steps in the method embodiment of FIG. 6. When the communication device 1200 is a network side device, the program or the instruction is executed by the processor 1201 to implement the steps in the method embodiment of FIG. 7, and a same technical effect can be achieved. To avoid repetition, details are not described herein again.

An embodiment of this application further provides a readable storage medium. The readable storage medium stores a program or an instruction. When the program or the instruction is executed by a processor, the method in FIG. 6 or FIG. 7 and the processes in the foregoing embodiments are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor, the processor is configured to run a program or an instruction, to implement the processes shown in FIG. 6 or FIG. 7 and the foregoing method embodiments, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes shown in FIG. 6 or FIG. 7 and the foregoing method embodiments, and a same technical effect can be achieved. To avoid repetition, details are not described herein again.

An embodiment of this application further provides a communication system. The communication system includes a terminal and a network side device. The terminal is configured to perform the processes in FIG. 6 and the foregoing method embodiments, and the network side device is configured to perform the processes in FIG. 7 and the foregoing method embodiments. A same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware only. The computer software product is stored in a storage medium (such as a ROM, a RAM, a magnetic disk, or an optical disc), and includes several instructions for instructing a terminal or a network side device to perform the methods in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, the implementations fall within the protection of this application.

1. A configuration method, comprising:
obtaining, by a terminal, configuration information of a non cell-defining synchronization signal block (NCD-SSB) or configuration information of a cell-defining synchronization signal block (CD-SSB), wherein
the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

2. The method according to claim 1, wherein the method further comprises at least one of the following:
obtaining, by the terminal, first information, wherein the first information is used to indicate at least one of the following: in a case that the terminal enters the idle state or inactive state, an NCD-SSB or a CD-SSB configured in a connected state remains valid or does not remain valid; and the terminal in the idle state or inactive state is capable of or is incapable of using an NCD-SSB or a CD-SSB configured in a connected state, or
obtaining, by the terminal, second information, wherein the second information is used to indicate at least one of the following: in a case that the terminal in the idle state or inactive state performs small data transmission (SDT), an NCD-SSB or a CD-SSB configured in a connected state remains valid or does not remain valid; and in a case that the terminal in the idle state or inactive state performs SDT, the terminal is capable of or is incapable of using an NCD-SSB or a CD-SSB configured in a connected state.

3. The method according to claim 1, wherein the configuration information of the NCD-SSB or the configuration information of the CD-SSB is carried in at least one of the following:
a radio resource control (RRC) release message;
an RRC configuration message;
an RRC reconfiguration message; and
a broadcast message.

4. The method according to claim 3, wherein time during which the configuration information of the NCD-SSB or the configuration information of the CD-SSB is invalid or unavailable comprises at least one of the following:
after a first preset time period after the terminal receives or demodulates a message carrying the configuration information of the NCD-SSB or the configuration information of the CD-SSB;
after a second preset time period after the terminal enters from the connected state to the idle state or inactive state;
after a third preset time period after the terminal selects or reselects a target cell;
after a fourth preset time period after the terminal selects or reselects a cell other than a target cell; and
a preset timer expires, wherein the preset timer is started in a case that a validity condition for the configuration information of the NCD-SSB or the configuration information of the CD-SSB is met.

5. The method according to claim 1, wherein a validity range of the configuration information of the NCD-SSB or the configuration information of the CD-SSB comprises one of the following: a target cell and an area in which a target cell is located.

6. The method according to claim 5, wherein the area comprises at least one of the following:
a radio access network notification area;
a public land mobile network;
a tracking area;
a paging area;
a central unit range; and
a distributed unit range.

7. The method according to claim 1, wherein the method further comprises at least one of the following:
in a case that the terminal selects or reselects a target cell or an area in which a target cell is located, determining, by the terminal, that the configuration information of the NCD-SSB or the configuration information of the CD-SSB is invalid,
in a case that the terminal selects or reselects a target cell or an area in which a target cell is located, determining, by the terminal, that the configuration information of the NCD-SSB or the configuration information of the CD-SSB is valid, or determining that the configuration information of the NCD-SSB or the configuration information of the CD-SSB is capable of being used in the idle state or inactive state,
in a case that the terminal selects or reselects a target cell or an area in which a target cell is located and a validity condition for the configuration information of the NCD-SSB or the configuration information of the CD-SSB is met, determining, by the terminal, that the configuration information is valid, or determining that the configuration information is capable of being used in the idle state or inactive state.

8. The method according to claim 1, wherein the validity condition for the configuration information of the NCD-SSB or the configuration information of the CD-SSB comprises one of the following:
the terminal receives or demodulates the message carrying the configuration information of the NCD-SSB or the configuration information of the CD-SSB;
the terminal enters from the connected state to the idle state or inactive state; and
the target cell is selected or reselected.

9. The method according to claim 4, wherein the target cell comprises at least one of the following:
a cell in which the message carrying the configuration information of the NCD-SSB or the configuration information of the CD-SSB is received or demodulated;
a cell in which the terminal is located before entering the idle state or inactive state;
a cell in which the terminal is located when entering the idle state or inactive state; and
a cell in which the terminal is located after entering the idle state or inactive state.

10. The method according to claim 1, wherein the method further comprises:
performing, by the terminal, a first operation in the idle state or inactive state according to the configuration information of the NCD-SSB or the configuration information of the CD-SSB, wherein
the first operation comprises at least one of the following:
small data transmission;
random access;
radio resource management measurement;
early measurement;
measurement corresponding to cell selection/reselection;
measurement corresponding to public land mobile network selection;
measurement corresponding to random access resource selection;
measurement corresponding to configured grant physical uplink shared channel resource selection;
receiving a paging message;
receiving a broadcast message;
receiving a paging early indication;
receiving a wake-up signal (WUS); and
another operation in the idle state or inactive state.

11. The method according to claim 10, wherein the small data transmission comprises at least one of the following: small data transmission without subsequent transmission and small data transmission with subsequent transmission, wherein the subsequent transmission comprises at least one of the following: configured grant transmission and dynamic grant transmission.

12. The method according to claim 10, wherein the performing, by the terminal, a first operation in the idle state or inactive state according to the configuration information of the NCD-SSB or the configuration information of the CD-SSB comprises at least one of the following:
performing, by the terminal, the first operation in the idle state or inactive state according to the configuration information of the NCD-SSB or the configuration information of the CD-SSB obtained through an RRC release message, an RRC configuration message, or an RRC reconfiguration message; and performing, by the terminal, the first operation in the idle state or inactive state according to the configuration information of the NCD-SSB or the configuration information of the CD-SSB obtained through a broadcast message;
in a case that the configuration information of the NCD-SSB or the configuration information of the CD-SSB is obtained through an RRC release message, an RRC configuration message, or an RRC reconfiguration message, and a broadcast message, performing, by the terminal, the first operation in the idle state or inactive state according to the configuration information of the NCD-SSB or the configuration information of the CD-SSB obtained through the RRC release message, the RRC configuration message, or the RRC reconfiguration message;
in a case that the configuration information of the NCD-SSB or the configuration information of the CD-SSB is obtained through an RRC release message, an RRC configuration message, or an RRC reconfiguration message, and a broadcast message, performing, by the terminal, a first partial operation of the first operation in the idle state or inactive state according to the configuration information of the NCD-SSB or the configuration information of the CD-SSB obtained through the RRC release message, the RRC configuration message, or the RRC reconfiguration message; and
in a case that the configuration information of the NCD-SSB or the configuration information of the CD-SSB is obtained through an RRC release message, an RRC configuration message, or an RRC reconfiguration message, and a broadcast message, performing, by the terminal, a second partial operation of the first operation in the idle state or inactive state according to the configuration information of the NCD-SSB or the configuration information of the CD-SSB obtained through the broadcast message.

13. The method according to claim 1, wherein the configuration information of the NCD-SSB or the configuration information of the CD-SSB comprises at least one of the following:
a physical cell identifier;
a transmit power;
a sending periodicity;
a sending position;
frequency information;
a synchronization signal block index; and
a quasi co-located resource with another synchronization signal block.

14. A configuration method, comprising:
sending, by a network side device, configuration information of an NCD-SSB or configuration information of a CD-SSB, wherein
the configuration information of the NCD-SSB is used to configure a corresponding NCD-SSB for a terminal in an idle state or inactive state, and the configuration information of the CD-SSB is used to configure a corresponding CD-SSB for the terminal in the idle state or inactive state.

15. The method according to claim 14, wherein the configuration information of the NCD-SSB or the configuration information of the CD-SSB is carried in at least one of the following:
an RRC release message;
an RRC configuration message;
an RRC reconfiguration message; and
a broadcast message.

16. The method according to claim 14, wherein
the terminal performs a first operation in the idle state or inactive state according to the configuration information of the NCD-SSB or the configuration information of the CD-SSB, wherein
the first operation comprises at least one of the following:
small data transmission;
random access;
radio resource management measurement;
early measurement;
measurement corresponding to cell selection/reselection;
measurement corresponding to public land mobile network selection;
measurement corresponding to random access resource selection;
measurement corresponding to configured grant physical uplink shared channel resource selection;
receiving a paging message;
receiving a broadcast message;
receiving a paging early indication;
receiving a wake-up signal WUS; and
another operation in the idle state or inactive state.

17. The method according to claim 16, wherein the small data transmission comprises at least one of the following: small data transmission without subsequent transmission and small data transmission with subsequent transmission, wherein the subsequent transmission comprises at least one of the following: configured grant transmission and dynamic grant transmission.

18. A terminal, comprising a processor, a memory, and a program or an instruction that is stored in the memory and executable on the processor, wherein the program or the instruction, when executed by the processor, implements the steps of:
obtaining, by the terminal, configuration information of a non cell-defining synchronization signal block (NCD-SSB) or configuration information of a cell-defining synchronization signal block (CD-SSB), wherein
the configuration information of the NCD-SSB is used to configure a corresponding NCD-SSB for the terminal in an idle state or inactive state, and the configuration information of the CD-SSB is used to configure a corresponding CD-SSB for the terminal in the idle state or inactive state.

19. The terminal according to claim 18, wherein the configuration information of the NCD-SSB or the configuration information of the CD-SSB is carried in at least one of the following:
a radio resource control RRC release message;
an RRC configuration message;
an RRC reconfiguration message; and
a broadcast message.

20. A network side device, comprising a processor, a memory, and a program or an instruction that is stored in the memory and executable on the processor, wherein when the program or the instruction is executed by the processor, the steps of the method according to claim 14 are implemented.
